(19) United States
(12) Patent Application Publication
(10) Pub. No.: US 2016/0184714 A1
(43) Pub. Date: Jun. 30, 2016

(54) SERIOUS GAME PLATFORM FOR DELIVERING MULTIPLE AND VARIED WORK PRODUCTS

(71) Applicant: Brennan MURPHEE, McLean, VA (US)

(72) Inventor: Brennan MURPHEE, McLean, VA (US)

(21) Appl. No.: 14/586,905

(22) Filed: Dec. 30, 2014

(51) Int. Cl. A63F 13/822; A63F 13/335

(52) U.S. Cl. CPC A63F 13/822; A63F 13/335

(57) ABSTRACT

A network gaming platform for ranking sources of information comprising an infrastructure for playing a serious game and including a game engine configured to manage execution of a serious game involving multiple players and at least one portfolio owned by one of the players, the portfolio comprising an identified information-providing expert and the portfolio having an ask price assigned thereto by the owner, wherein play of the serious game via the engine comprises sales of the portfolios by and between the players through a bid-ask formula for a predetermined length of time, whereby the expert in a portfolio having the greatest dollar value at the end of the period of time is ranked the highest.

### BACKGROUND OF INVENTION

1. Field of the Invention

The invention relates to serious game platforms

2. Description of the Prior Art

Reduced to its formal essence, a game is an activity among two or more independent decision-makers seeking to achieve their objectives in some limiting context. A more conventional definition is that a game is a context with rules among adversaries trying to win objectives. The purpose of simple games is to have fun.

Serious games are games designed for a primary purpose other than entertainment. In the course of playing a serious game, a useful artifact or by-product is produced. Stated differently, serious games harness fun and make it produce work.

Serious games involve the use of electronic games technologies and methodologies and are meant to take on real-world problems. “Serious games” are therefore used in a variety of scenarios, including education, training, assessment, recruitment, knowledge management, military and scientific research. Serious games have an explicit and carefully thought-out educational purpose and are not intended to be played primarily for amusement.

To date, no serious game platform exists that may be employed to deliver multiple and varied work products. Ideally, such a platform would be open for users to create additional serious games which would become integral parts of the platform.

The platform would allow participants to invent a game and submit it to the platform for development. This ideal platform would constitute a marketplace of games which have useful output beyond the game itself. Moreover, the individual games played on the platform would also have the potential to create new markets in the space that they operate.

It is an object of the present invention to provide a novel and unique serious game platform, system, and method capable of delivering multiple and varied work products, and which is open for the creation of additional serious games which are integral parts of the platform.

### SUMMARY OF THE INVENTION

These and other objects are realized by the present invention, one embodiment of which relates to a network gaming platform for ranking sources of information comprising an infrastructure for playing a serious game and including a game engine configured to manage execution of a serious game involving multiple players and at least one portfolio owned by one of the players, the portfolio comprising an identified information-providing expert and the portfolio having an ask price assigned thereto by the owner, wherein play of the serious game via the engine comprises sales of the portfolios by and between the players through a bid-ask formula for a predetermined length of time, whereby the expert in a portfolio having the greatest dollar value at the end of the period of time is ranked the highest.

### DETAILED DESCRIPTION OF THE INVENTION

The present invention is predicated on the discovery that the serious game platform described herein may be employed for delivering multiple and varied valuable work products

In the following detailed description of an illustrative embodiment, while particular aspects are shown and described, it will be apparent to those skilled in the art that, based on the teachings herein, changes and modifications may be made without departing from the spirit or scope of the disclosure. Therefore, the following detailed description is not to be taken as limiting.

One embodiment of the invention relates to a serious game platform capable of ranking sources of information. In order to describe this aspect of the invention it is necessary to define the intrinsic value of information. One paradigm for valuing information concerns scenarios where information is bought; i.e., the provider of the information charges the receiver a fee. Fees can be compared and thus the bought information can be ranked by value. For example, an auto technician might diagnose a broken car by charging $125 to plug in a specialized computer that identifies problems in the vehicle. The resulting information is ultimately what you are paying for. An attorney, who performs legal services may charge $350/hr. In each case, the buyer of the services receives information that they couldn't easily assemble themselves and that information is put to use in a variety of pursuits that are important to the buyer. Via fee comparisons different types of information can thus be compared and ranked against other similar information exchanged for fees; however, this system is not based on the intrinsic value of the information.

Rather, the information is informally organized by value based solely on the consumer's subjective valuation of the information obtained; i.e., the services of the auto technician, doctor or attorney. The true intrinsic value of information is dependent upon the source of the information. Therefore, the ranking of information by value would necessarily depend on the ranking of the sources of that information. In evaluating the information provided by the auto technician, doctor or attorney, one would need to have a system for value-ranking these experts in the field.

The embodiment of the invention described below is predicated on the discovery of a platform/system/method for determining and ranking the intrinsic value of information.

The invention is illustrated below by describing a serious game platform/system/method for value-ranking information providing experts. For ease of description, the serious game will be referred to as Dipole. Dipole is a serious game designed to rank information by its intrinsic value. Those skilled in the art will realize from the description that follows that the game is not limited to any particular type of information but enables the ranking all types of information according to its intrinsic value. Ranking is generically defined as the relationship between a set of items such that, for any two items, the first is either ‘ranked higher than’, ‘ranked lower than’, or ‘ranked equal to’ the second. In mathematics, this is known as a weak order or total preorder of objects. It is not necessarily a total order of objects because two different objects can have the same ranking. The rankings themselves are totally ordered. For example, materials may be totally preordered by hardness, while degrees of hardness are totally ordered.

Rankings exist for a variety of things in all cultures. In American culture, people are often introduced to rankings through such things as college football top 25 lists, golf & tennis world rankings, Fortune 500 lists, lists of top grossing movies, songs, you tube video popularity based on number of views, etc. Rankings occasionally form the basis of controversy as when rankings vie for objectivity only to be criticized for their subjectivity. The US World College Rankings is an example. Is one college objectively better than another? Certainly, but is Harvard better than Yale? The answer may be yes and no. Less controversial forms of ranking occur as a result of some competition or tournament such as the US Open in golf and tennis. Who is number 1 just is who has won the competition. This is a fleeting ranking for one tournament but it may be valued as more than a year long ranking.

Thus, companies, movies, songs, colleges, athletes and a plethora of diverse things can be and are often ranked. Information is one of those things that gets ranked and most people in the digital age are exposed to this via the Google search engine. When a user submits a query, Google provides a set of “search results” which is a list of webpages or documents that may best satisfy the user's query. These lists are actually ranked lists produced by Google algorithms. These algorithms are rich and diverse but are also largely based on a simple popularity measurement. How does such a measurement work?

One of Google's models of popularity ranking is based, for example, on academic publishing: If I am a respected researcher and I publish a respected paper, other respected academics will refer to my work in their citations. A paper which is cited frequently by numerous academics may be for the purpose of praising/agreeing or it may be for the purpose of disagreeing/rejecting but either way both reasons for citation show that the paper is popular. Popular papers are thus simply cited most frequently by others. To rank papers by popularity, you simply count the citations and then place them into an ordered list. Thus, Google works mostly on a simple principle whose origin is that of the academic publishing world.

How does this principle work in the search engine world? When I query Google for a variety of things such as “baseball t-shirt” or “DC museums good for kids” Google produces a list of webpages that may satisfy my interest in searching for those phrases. It does this by counting hyperlinks which point to a particular web page or web resource. If 120,000 webpages point to www.dcmuseumforkids.com with the phrase “DC museums good for kids” somewhere in or near their link, then Google tallies that together and ranks it with other webpages of similar popularity. Google counts inbound hyperlinks to determine popularity in the same way academics may count published paper citations to determine a paper's popularity or significance. Through Google's algorithms, the most popular websites end up on the first page of the Google search results. So, despite all of the various and potentially numerous algorithms Google applies to tweak search results, this is the basic one that makes Google function.

However, ranking information by popularity is not the same think as ranking it according to its intrinsic value. What is lacking is the data regarding intrinsic value. Those skilled in the art will recognize that the serious game platform/system/method of the invention will enable the ranking of virtually any type of information according to it's intrinsic value.

As noted above, any value of information is determined by what someone will pay for it. To locate the most valuable information, a good first step would be to examine experts traditionally demanding the highest fees or costs for the information they can provide, e.g., attorneys, doctors and specialists of every kind. The second step would be to focus in on those persons who are at the top of their field. These experts, however, are difficult to locate, rank and utilize. This is a major problem, for example, among financial securities dealers who conduct in depth background checks on companies into which they wish to invest. Often, they will hire subject matter experts to vet a company's viability and potential. But locating domain specific experts is difficult. It often happens that one has an interest in locating not only an expert in a particular field but, more precisely, the best such expert. For example, one may wish to know who is the top knee surgeon in Houston, Tex.; the top patent attorney in Chicago, IL with a degree from the University of Chicago; or the most knowledgeable archeologist to call for construction projects in Sao Paulo halted by antiquities finds during construction? These types of queries cannot be satisfied by a Google search for a very good reason: The data Google's algorithms requires in order to rank information properly does not exist in these examples. There is no set of databases on the Internet that ranks experts by the intrinsic value of their information.

Certainly, there are databases and directories of experts as well as compilations of their average salaries and the like. Within the legal and medical field, there are directories which allow doctors and attorneys to provide peer reviews of their respective colleagues and by tallying these peer reviews, one can semi-rank such professionals. But most of these are subjective lists compiled by more or less well meaning people and which today probably generate value based on the purchase prices of such publications and resources. More useful would be a system that ranked information by its intrinsic value in an ongoing fashion similar to a securities market which is open perpetually. Dipole is a serious game platform/system/method that results in ranked lists of experts according to the intrinsic value of their information. The object of the game is to create perpetual valid portfolios of experts. Play of the game is as follows.

A player conducts research about experts that interest them and that they think would be valuable resources in the game; e.g., billionaires, celebrities, scientists, bankers, attorneys, doctors and the like. Upon locating such a person, the player submits the expert into the game using a predetermined formula. The player tags the expert with a dollar value, which becomes the asking price of the expert in the game.

The expert now becomes part of a market and profile of the expert is generated and displayed on a unique web page reserved solely for that expert. Other players in the game can now interact with that expert by buying and selling him or her.

For example, player A submits Warren Buffett as an expert in stock valuation with a $100 asking price. Player B can buy Buffett for the $100 or he can bid a lower amount which player A can ignore, accept or reject. Just as in a securities market, there are two competing notions for what is the objective value of Warren Buffet at any one time: the asking price submitted by the owner and the bid price submitted by the offerer. Between the bid and the ask, as in a securities market, is the objective value of the expert and derivatively, the intrinsic value of the expert's information. But, how does a player outperform other players and “win the Dipole game”?

In Dipole, every expert has an asking price and a bid price. The player who controls a particular expert can only control the asking price. There needs to be an objective value of the expert and that arises during the game when other players bid on the experts who have been submitted. To win Dipole, you have to submit experts that other players will find objectively valuable and will bid or buy those experts to place them into their own portfolio. When other players bid on experts in A's portfolio or buys experts out of A's portfolio, the portfolio's objective value rises. The goal of the game is to have the highest objective portfolio value at any point during the game.

Dipole is based on the actual financial exchange of real money and includes real transactions of real money between players. Thus, the value of the experts is based upon an objective monetization mechanism that each player participates in by virtue of playing the game. Thus, within Dipole, the underlying objective value of an expert is dependent upon the game having a connection to a real world tangible monetization mechanism.

Following is an explanation of the mechanism of monetization in the serious game of Dipole. Referring again to a game wherein A submits the portfolio of Warren Buffett. [It is important to note that only one person can “own” any particular portfolio at any one time.]

The monetization of Warren Buffet can based on a variety and evolving set of mechanisms; for example, online advertising space. In Dipole when Warren Buffett is submitted and is owned in A's portfolio, A can place advertising on its web page. Observers of the Warren Buffet portfolio webpage will see and possibly click on the ads. By utilizing a well understood code, A can upload ads to a website and earn money on clicks on the ad. By analogy, imagine A “owned” particular Wikipedia articles. This would allow A to place ads on those webpages. Dipole works similarly in that when A submits the expert, Warren Beatty into the game, A maintains the written profile of that expert. This written profile is analogous to a Wikipedia article. It affords A the opportunity to explain the objective value of Warren Beatty to other players which may induce them to bid or buy that portfolio.

A more complicated monetization mechanism is where Dipole provides an online expertise marketplace. In this paradigm, as experts are submitted, they quickly became billable consultants in a virtual company owned by A. As the owner of this virtual company A would derive marketing fees for each engagement of an expert which could, for example, comprise a portion of the overall fee charged by the expert in delivering information to purchasers. It will be understood by those skilled in the art that any monetization paradigm may be employed in the serious game of Dipole.

Other embodiments of the invention include but are not limited to:

1. A game for identifying the top songs, books, movies, etc. This could piggy back off of affiliate programs such as the Apple iTunes affiliate program (http://www.apple.com/itunes/atfiliates/). While Apple has many ways to organize and sort songs and movies and books, it isn't always clear which top ranked options are based purely on sales or other factors. The platform of the invention could provide other facets such as views, previews, etc., as metrics to chart and graph sales thereof.

2. A competitive math game to solve math problems. The competitions run continually and, at certain intervals, those with the highest points, win the game for recognition and reward. Such a game would be of interest to prospective colleges and universities to determine the smartest pre-collegiate mathematicians. Universities colleges could fund the games in exchange for identifying top students that they can then recruit.

3. A game funded by intelligence or law enforcement agencies structured to locate suspected terrorists. The object of the game is to identify tangible proof of the whereabouts of a particular person based on verifiable evidence. The rewards would be based on the age and significance of the evidence. For example, if one could prove a wanted person was in a particular city a month ago, this might win a reward of $1000. Another example might be that if one can prove a wanted person talked with or met with a second person, they might win $10,000. All of these examples stand in contrast to the traditional “reward leading to the arrest of types of reward that go towards finding wanted people. The game of the invention could accelerate the discovery of wanted people by breaking up larger rewards and spreading them across a network of people working together to apprehend a suspect. The information sharing among the players would be superior to those of traditional intelligence apparatus.

4. A game designed to locate and hire competent people. Businesses receive qualified candidates for interviews and upon hiring a person referred to the company, the headhunter is paid a percentage of the first year's salary. Typical scenarios involve people submitting their resumes to headhunters who are paid by either the job applicant or the hiring company. The game is played every time a new person joins the site and submits their resume. Any number of people may try to find a job for that person. The winner is the resume submitter's or hiring company's choice.

5. A game designed for entities in need of certain types of photographs. Their needs are posted and then submitted to any number of photographers. The owner of the portfolio chosen by the submitting entity would receive a predetermined award.

6. The game platform of the invention could be used by advertisers seeking people to hand out flyers on public streets. They upload the flyer and players download and print it. On each flyer, there is a scannable barcode or qr code. At the end of each day, the person whose handouts resulted in the highest number of responses wins the game and reward. Another form of winner of the game would be whomever generated, e.g., the most visits to a website.

It will be understood by those skilled in the art that the serious game platform of the invention may be operated on any device conventionally employed to play games, such as, e.g., a mobile device such as an iphone or ipad or Android phone. Interaction with the game platform may be accomplished by, e.g., txting, phoning or other means.

The platform of the invention may also be designed to permit users/players to introduce their own serious games thereinto.

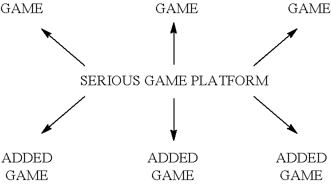

What is claimed is:

1. A network gaming platform for ranking sources of information comprising an infrastructure for playing a serious game and including a game engine configured to manage execution of a serious game involving multiple players and at least one portfolio owned by one of said players, said portfolio comprising an identified information-providing expert and said portfolio having an ask price assigned thereto by said owner, wherein play of the serious game via said engine comprises sales of said portfolios by and between said players through a bid-ask formula for a predetermined length of time, whereby the expert in a portfolio having the greatest dollar value at the end of said period of time is ranked the highest.
